(19) United States
(12) Patent Application Publication
(10) Pub. No.: US 2002/0130939 A1
(43) Pub. Date: Sep. 19, 2002

(54) System for post processing of printer output

(76) Inventor: Steve A. Jacob, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/814,365

(22) Filed: Mar. 19, 2001

(51) Int. Cl. B41J 2/01

(52) U.S. Cl. 347/102; 347/101

(57) ABSTRACT

A printer is provided with a pressure/heater roller device downstream from the printer's printing zone by a media path distance greater than the length of a sheet of print media passing through said printer.

### BACKGROUND OF THE INVENTION

1. Field of the Invention

The present invention generally relates to printers. More particularly, it relates to apparatus for improving the print quality of inkjet printers by improving their printhead output (i.e., “post processing”).

2. Description of the Related Art

Inkjet printers form a printed image by printing a pattern of individual dots at particular locations on a print medium such as a sheet of paper. The dot locations can be visualized as being small dots in a rectilinear array. These locations are sometimes called “dot locations”, “dot positions”, or “pixels”. Thus, an inkjet printing operation can be regarded as the filling of a pattern of dot locations with dots of ink. The dots themselves are formed by ejecting very small droplets of ink onto the print medium.

Thus, an inkjet printer includes a movable carriage that supports one or more printheads that each have one or more ink ejection nozzles. The printheads are moved repeatedly across the width of the print medium upon which the ink dots are placed. At each of a designated number of increments of this movement across the width of the medium, each nozzle is caused to eject ink, or to refrain from ejecting ink. After each such completed swath, the medium is moved forward by the width of the swath; the printhead carriage is then returned to its original position from which it begins its next swath. In bidirectional printing, the printhead will print in both directions. In either case, the movement of a sheet of print media through the print zone is carried out in a “stop and go” or “discontinuous” manner. This discontinuous motion is to be contrasted with a smooth continuous motion in which a sheet of paper is delivered to the print zone, and with which it is thereafter removed from said print zone. All of these printing operations are carried out according to program output of a microprocessor. Thus, by proper selection and timing of the signals from the microprocessor, a desired printed image can be properly placed on a sheet of medium.

In order to obtain multicolored printing, color thermal inkjet printers commonly employ a plurality of printheads mounted in the printhead carriage. Each printhead dispenses ink of a different color. The most commonly used base colors are cyan, magenta, yellow, and black. These base colors are produced by depositing a drop of the required color onto a given dot location. Secondary or shaded colors are formed by depositing multiple drops of different base color inks onto that same dot location. This overprinting of two or more base colors produces secondary colors according to well known optical principles.

Unfortunately, inkjet printers are not able to print high density plots on plain paper (and especially bond paper) without the print suffering, to some degree, at least two forms of print quality degradation. The first print quality degradation is that an ink-saturated sheet of paper is often transformed into a wavy or cockled configuration. The second form of print quality degradation is that adjacent colors can be mechanically smeared before they are completely dry. The effects of these forms of print quality degradation can vary from being mildly annoying to a human reader to being commercially unacceptable.

The underlying reasons for these problems are generally known. For example, it is known that when an absorbent print medium such as a sheet of paper (and especially bond paper) absorbs the liquid solvent constituent (typically water) of an ink, the paper fibers in that area expand until the solvent has evaporated or otherwise dispersed. Because the dampened area of the print media is typically constrained in the plane of the paper by adjacent less damp areas and/or by the paper advance mechanism, and/or by the underlying platen, the dampened area has a tendency to buckle (“cockle”) upwards toward the nozzle.

A related problem is so-called “curling” of a sheet of paper that has received a great many high density plots on one side of the sheet relative to the number received on the opposite side of the sheet. Curling occurs as a result of differential absorption of an ink solvent on the two sides of a sheet of paper that has undergone a duplex printing operation. Once such a sheet of paper exits from the feed mechanism it is no longer under tension and, hence, has a tendency to curl in the direction of the side with the lowest ink density. Depending upon the extent of the curl, which is a function of both overall image density and throughput speed, the printed surface may be urged against various overlying stationary parts of a printer that are generally located between the carriage and the output tray; hence, the densest parts of the image tend to become smeared by these undesired contact(s). It is also known that a print medium becomes damper, and remains damper for a longer time, as more and more different colored ink is applied on the same area of a given sheet. Thus, the probability of buckling or curling increases when ink density of a print image is increased in order to produce intense black or colored portions of a dense image.

The probability of ink smearing also increases when the speed of an inkjet printer increases and less time is available for the ink to dry, or when the distance between the paper and the nozzle is reduced in order to more accurately define the size and location of the individual dots of ink. Herein again, those skilled in the inkjet printing arts also will appreciate that problems associated with scraping of the nozzles against raised portions of the image are most noticeable during high speed multiple pass printing operations in which the nozzles pass several times over the same, progressively rising, area. The previously noted curling problems also are particularly noticeable in high speed, high throughput (single pass) printing modes in which a large quantity of ink is deposited over a relatively large area in a relatively short period of time.

Aside from refining the ink compositions themselves, the above noted ink drying and/or smearing problems generally have been addressed by accelerating evaporation of a given ink's solvent component by artificial means (e.g., heating) and/or by allowing the ink solvents more time to evaporate. Accelerated evaporation of an ink's solvent has been accomplished by (1) heating the print medium before it receives any ink, (2) heating the print medium as it is receiving ink and/or (3) by circulating relatively hot dry air on to a freshly printed sheet just after it leaves the print zone. For example, U.S. Pat. No. 5,668,584 (“the '584 patent”) teaches use of an inkjet printer that applies heat to the underside of a sheet of paper which is supported by a screen-like platen. A heat generator is placed under the screen-like platen. The screen-like nature of the platen allows transfer of heat by radiation and convection from a heat generator (e.g., a halogen lamp) to the underside of the sheet of paper before, during, and after it receives a printed image. Approximately the same amount of heat is applied, more or less simultaneously, to a preprinting portion of the overall inkjet print zone, to an ink-applying portion of the print zone, and to a post-printing portion of the print zone. Unfortunately, each of these heating operations, to some degree, tends to interfere with proper adherence between the ink and the print medium. These heating techniques also may cause less densely inked areas to shrink and/or to become brittle and/or discolored.

Ink drying problems also have been addressed by providing a relatively long time delay between the time an ink is placed on the print medium and the time when the print medium receives another colored ink overlay. These problems also have been addressed by extending the time between when the ink is first dispensed and when the print medium finally leaves the inkjet printer. For example, U.S. Pat. No. 5,608,439 (“the '439 patent”) discloses use of a densitometer to prevent rubbing of an inkjet printing mechanism against still wet ink on a buckled or curled sheet of an absorbent print medium such as paper. For example, after an inkjet printer has printed one swath of a high density image, printing of the next swath is delayed as a function of the maximum density of the ink drops deposited on the print medium for the printed swath(s). Consequently, the required delay in printing the next swath is dependent on the print mode employed. Preferably, this process employs a formula with empirically derived constants to allow sufficient time for the solvent in the ink to evaporate or otherwise disperse and/or to permit any buckling or curling of the print medium to stabilize. In one preferred embodiment of the invention disclosed in the '439 patent, a maximum density is calculated by counting drops of ink in each of several overlapping grids. The magnitude and location of the maximum density grid on a prior page is also used to limit the throughput of a next page until a sufficient time delay has elapsed to ensure that ink on the prior page will not be smeared when it comes into contact with the next page. Those skilled in this art will appreciate that these ink drying time extension processes generally produce better print quality than the above-noted heating methods, but they rather drastically decrease the throughput of an inkjet printer. Consequently, this extended drying time solution to the ink smearing problem has not been well received in the industry, mainly because of its current emphasis on increasing the throughput of inkjet printers so that they can keep up with the increasing throughput of central processing units.

In response to this set of interrelated ink drying and/or ink smearing problems, applicant has developed a printing system wherein the effects of time and heat on the drying of an inkjet dispensed ink can be improved to produce higher quality inkjet printing without suffering those unacceptable time delays associated with simply “waiting for” such an ink to sufficiently dry. The system of the present patent disclosure generally uses a heater/pressure device to dry the inkjet printer's printhead output.

### SUMMARY OF THE INVENTION

Applicant has found that better print quality is obtained when print output is heated, primarily by conduction heating, under pressure, well beyond the print zone, by a heater/roller type post-processing device. The printer can be any printer that employs a liquid print composition (inkjet printer, electrophotographic printer employing liquid toner, etc.). The more preferred embodiments of this invention, however, will be used in conjunction with inkjet printers. Hence, inkjet printers will be used to further illustrate this invention. Some of the more preferred embodiments of applicant's system for post processing of a printing composition are comprised of (1) an inkjet printer's printhead, (2) a pressure/heater device and (3) a defined physical relationship of the printhead to the pressure/heater device. Generally speaking, the inkjet printers of this patent disclosure will employ a printhead generally comprising a plurality of inkjet nozzles that are attached to a carriage that operates above a print zone. The nozzles dispense droplets of ink onto the surface of a sheet of print medium such as a sheet of paper. This ink dispensing operation is carried out in microprocessor-controlled ways well known to those skilled in this art.

The inkjet printers of this patent disclosure differ from those of the prior art in that they employ a pressure/heater roller that is placed well beyond the print zone. For the purposes of this patent disclosure, the expression “well beyond the print zone” can be taken to mean that the pressure/heater device is positioned at least the length of a sheet of print media being printed upon by the printer's printhead. Thus for a standard sheet of 8½×11 inch paper, this “well beyond the print zone” distance will be at least 11 inches beyond the print zone as measured along the media path followed by the sheet of print media after it leaves the print zone. The sheet's traversing of this distance serves two purposes. It gives the ink an opportunity to complete a first part of its overall drying process. It also allows the sheet to become disengaged from a sheet transport device that carries the sheet through the print zone before that sheet is engaged by applicant's pressure/heater device.

The pressure/heater device then heats the medium, and the ink that has been deposited on it, under pressured conditions in order to cause a controlled further drying of the ink. This pressure/heater device preferably is a two roller system wherein at least one heat source is disposed inside at least one roller of the two roller system. The two rollers create a pressured, rolling interface at their respective outer or circumferential surfaces. Thus, the print media (e.g., paper) is nipped into, pressed between and conducted through the two cooperating rollers. These circumstances contrast with the heating system taught by the '584 patent in that the present pressure/heat roller device delivers conductive heat (as well as some convective heat) to the print media (and the ink deposited on it) after that ink has had the opportunity to partially dry as it travels from the print zone to the pressure/heater roller device. Moreover, the conductive heat of the present invention is delivered under pressured conditions. Thus, in effect, the print media is squeezed between the two contacting rollers while receiving conductive heat from the roller surface of at least one of the two rollers.

Thus, the inkjet printer embodiments of this patent disclosure can be thought of as being comprised of a printhead for inkjet printing on a sheet of print media in a print zone and a pressure/heater device that is positioned downstream from the print zone by a media path distance which is such that a sheet of media leaves the print zone before it enters the pressure/heater device. In some of the more preferred embodiments of this invention: (1) the media path distance is at least 11 inches, (2) the media path between the print zone and the pressure/heater device is substantially linear, (3) the pressure/heater device is comprised of a powered pressure roller and a passive or unpowered heater roller and (4) the pressure/heater roller system is used as a thermal transfer overlay device as well as a printing composition drying device.

### BRIEF DESCRIPTION OF THE DRAWINGS

FIG. 1 shows an inkjet printer having a print head and having a pressure/heater device positioned downstream from the print head according to the teachings of this patent disclosure.

FIG. 2 shows the inkjet printer of FIG. 1 further provided with a thermal transfer overlay device.

### DETAILED DESCRIPTION OF THE INVENTION

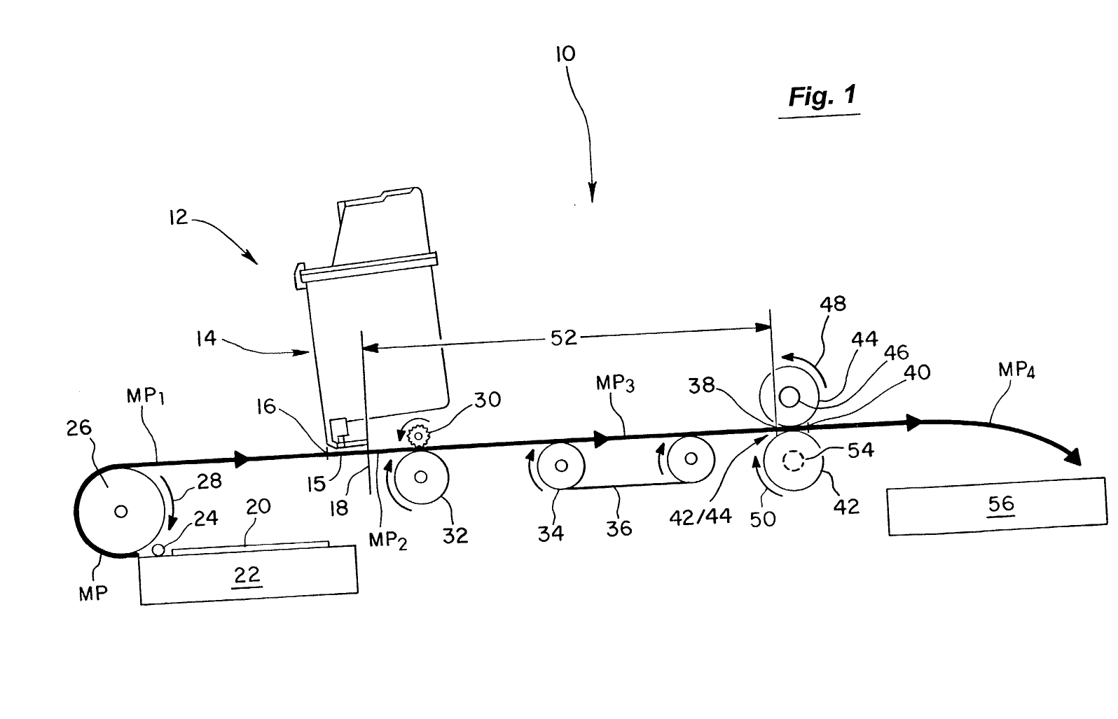

FIG. 1 depicts certain particularly relevant components of an inkjet printer 10 made and positioned according to the teachings of this patent disclosure. Such an inkjet printer 10 has a printhead 12 which supports one or more inkjet cartridges 14. By way of a well known example, the printhead 12 may support four separate ink cartridges for black, yellow, magenta and cyan ink. FIG. 1 also depicts a print zone 15 wherein ink is sprayed from one or more nozzles on to a sheet of print media such as a sheet of paper. This print zone 15 can be regarded as generally extending from a point 16 on the media path just before the ink nozzle(s) to a point on the media path just after the ink nozzle(s). Thus, for the purposes of this patent disclosure, the expression “well beyond the print zone” implies beyond a point in the media path that is intersected by a vertical plane 18 that lies just beyond the rear end of the inkjet nozzles.

FIG. 1 also depicts a media sheet 20, such as a sheet of paper, about to be removed from a tray 22 by the action of a pick roller 24. Such pick actions and the various devices used to carry them out are well known in the cut sheet handling arts. In any case, the pick roller 24 delivers a media sheet 20 to a first part MP₁ of a media path that traverses the inkjet printer 10. By way of example only, this first part MP₁ of the media path is depicted as being initially directed over the outside surface of a powered roller 26 that turns in the clockwise direction indicated by arrow 28. The powered roller 26 can be considered as the initial means by which an individual media sheet 20 is delivered to the print zone 15 i.e., to point 16. To a large degree, the motion of the print media sheet 20 between the powered roller 26 and the print zone 15 is continuous in nature. That is to say that once the sheet is taken from the tray 22 and delivered to the action of the powered roller 26, the sheet moves in a generally smooth, continuous manner by virtue of the fact that the powered roller 26 rotates at a substantially uniform speed.

This situation is to be contrasted with that same sheet's discontinuous manner of movement through the print zone 15 as it is receiving ink from the ink dispensing nozzles. To this end, the print zone 15 is shown provided with its own print zone sheet movement or driver device 30/32 which, in a highly generalized sense, is shown comprised of a starwheel 30 and a complementary exit roller 32. Driver devices of this kind are commonly used to provide stop-and-go movement to a sheet of paper as it passes through an inkjet printing zone. The print zone 15 also may be considered as a second part MP₂ of the overall media path. Again, this distinction between the first part MP₁ of the media path and this second part MP₂ of the media path is made because media movement through the print zone 15 is of a “stop and go” or “discontinuous” nature. This all goes to say that this discontinuous motion through the print zone is separate and distinct from a smooth continuous motion in the first part MP₁ of the media path, i.e., over the powered roller 26.

As was previously noted, motion along that portion of the media path going through the print zone 15 is irregular or discontinuous in nature owing to the fact that the ink dispensing nozzles must be repeated moved laterally across the width of the print medium (e.g., across the width of a sheet of paper). Again, at each of a designated number of increments of this lateral or widthwise movement across the medium, each of the nozzles is caused to either eject ink or to refrain from ejecting ink according to the programmed output of a controlling microprocessor. Each completed lateral movement across the medium will therefore print a swath approximately as wide as the number of nozzles arranged in a column on the ink cartridge multiplied by the distance between nozzle centers. Thus, after each such completed widthwise movement or swath, the medium is moved forward along the media path the width of the swath, whereupon the ink cartridge either returns to its starting position and begins its next swath or prints another line of information on its way back to its original position (i.e., bi-directional printing). Again, this discontinuous or stop and go motion through the print zone can be delivered by mechanical actions well known to those skilled in the inkjet printer manufacturing arts, e.g., by the starwheel 30/complimentary exit roller 32 system shown in FIG. 1.

After leaving the print zone 15, a media sheet 20 continues along a third part MP₃ of the media path under the action of another media path drive device 34/36 until it reaches another media path portion MP₄. This MP₄ part of the media path is generally located between point 38 and tray 56. Preferably, the media path drive devices 34/36 that takes the sheet from the print zone and delivers it to a pressure/heater device 42/44 is a belt type sheet transport device (e.g., powered roller 34 and endless belt 36) that does not “grip” the sheet of media 20 in order to advance it along the media path MP₃ that leads to point 38. Be that as it may, this media path device 34/36 delivers the sheet 20 to a zone 38/40 generally defined by the interface of applicant's pressure/heater roller device 42/44. That is to say that the leading edge 38 of this zone can be thought of as the place where the sheet 20 is first nipped and then placed in moving contact with the rollers of the pressure/heater device 42/44. The end point 40 of this zone can be thought of as the point where the rear side of the media sheet 20 is released from contact with the pressure/heater device 42/44. In a preferred embodiment of this invention the forward movement of the sheet through the pressure/heater roller device 42/44 will also provide enough momentum to the sheet to deposit it in a sheet collection tray 56.

The pressure/heater roller device 42/44 is preferably comprised of a single pressure roller 42 and a single heater roller 44. In some of the more preferred embodiments of this invention, the pressure roller 42 is powered and the heater roller 44 is passive. That is to say that free turning heater roller 44 is turned or driven by the powered pressure roller with which it is in pressured, rolling contact. The heater roller 44 is shown turning in a counterclockwise direction 48 while the pressure roller 42 turns in a clockwise direction 50. Consequently, a sheet of media 20 will be nipped and then pulled through the zone 38-40 by the powered roller action delivered by the pressure/heater roller device 42/44. The heater roller 44 is shown provided with a heat source 46 such as a halogen tube, induction heater element, etc.

The temperature and pressure conditions existing in the pressure/heater devices 42/44 of this patent disclosure can vary considerably. Moreover, they can vary with respect to each other and they can vary with respect to the residence time of a sheet of print media (e.g., paper) in such a pressure/heater device. Generally speaking, the temperature of the roller surface of the heater roller 44 will range between about 300-375° F. Temperatures between about 330° F. and 375° F. are somewhat preferred in those cases where water based inks are employed in the inkjet printing process. The pressure conditions experienced by a sheet of media, and especially a sheet of paper, will generally range between about 50 and about 150 psi. Pressures between about 65 and about 130 psi are somewhat preferred, especially when the heater roller temperature is between about 330° F. and about 375° F.

The residence time of a sheet of media in the pressure/heater device 42/44 is largely determined by the angular velocity of the powered drive roller (e.g., pressure roller 42). Typical residence times for an 8½×11 inch sheet of paper will be from about 2 to about 8 seconds per sheet. Residence times of about 3 to about 6 seconds are more preferred. These preferred residence times generally correspond to 8½×11 inch paper processing rates of about 16 to about 32 sheets per minute. Generally speaking, the shorter residence times will be used as the operating temperature is raised. For example, the lower end of the residence time range (e.g., 2-3 seconds) will generally be preferred as the temperature is raised toward the upper end of its preferred range (e.g., 330-375° F.).

Preferably, a media sheet 20 is powered through the pressure roller-heater roller interface in a smooth continuous fashion. This smooth, continuous action extends to the media path segment generally designated as MP₄ in FIG. 1. This smooth, continuous action is to be again contrasted with the irregular, discontinuous action experienced by the media sheet 20 in the print zone 15. That is to say that the continuous motion through the pressure/heater roller 42/44 is qualitatively different from the stop and go (i.e., discontinuous), motion through the print zone provided by the print zone driver device 30/32. Thus, it is highly preferred that the sheet 20 be completely released or disengaged from the discontinuous action provided by the print zone driver device 30/32 before it is delivered to the continuous action provided by the pressure/heater device 42/44.

Again, a transition between these two kinds of sheet movement is preferably accomplished through use of a roller/belt device 34/36 that does not grip the sheet of media 20 as it advances it from the print zone end point 18 to the pressure heater device 42/44. Be the sheet transport transition apparatus as it may, the distance 52 between the end 18 of the print zone 15 and the beginning 38 of the pressure roller 42/heater roller 44 nip or interface is preferably greater than the length of the print media sheet 20 being so advanced. For example, in the case of a standard 8½×11 inch sheet of paper, this distance 52 preferably will be greater than 11 inches.

FIG. 1 also shows the media path part MP₃ being linear in nature, i.e., linear over the entire length of line 52. This MP₃ part of the media path could, however, be curved in nature as well. In such case, the direct or straight line distance between the end of the print zone 18 and the pressure heater device 42/44 will be less than the length of the media (e.g., less than 11 inches). Nonetheless, the curved media path distance is preferably greater than the length of the sheet media (e.g., greater than 11 inches in the case of a standard 8½×11 inch sheet of paper).

It also should be appreciated that either or both of the rollers 42 and 44 can have a heater device. Thus, the pressure roller 42 is shown, in phantom lines, provided with a heater 54 as well. Similarly, either or both of the rollers 42 and 44 can supply the pressured rolling action that pulls the media sheet 20 through the roller 42, roller 44 interface. Regardless of the identity of the powered roller, after clearing point 40 in the media path MP₄, the sheet is delivered to a sheet collection tray 56. Thereafter, a stack of such sheets can be gathered by hand or subjected to other mechanical sheet handling operations not shown.

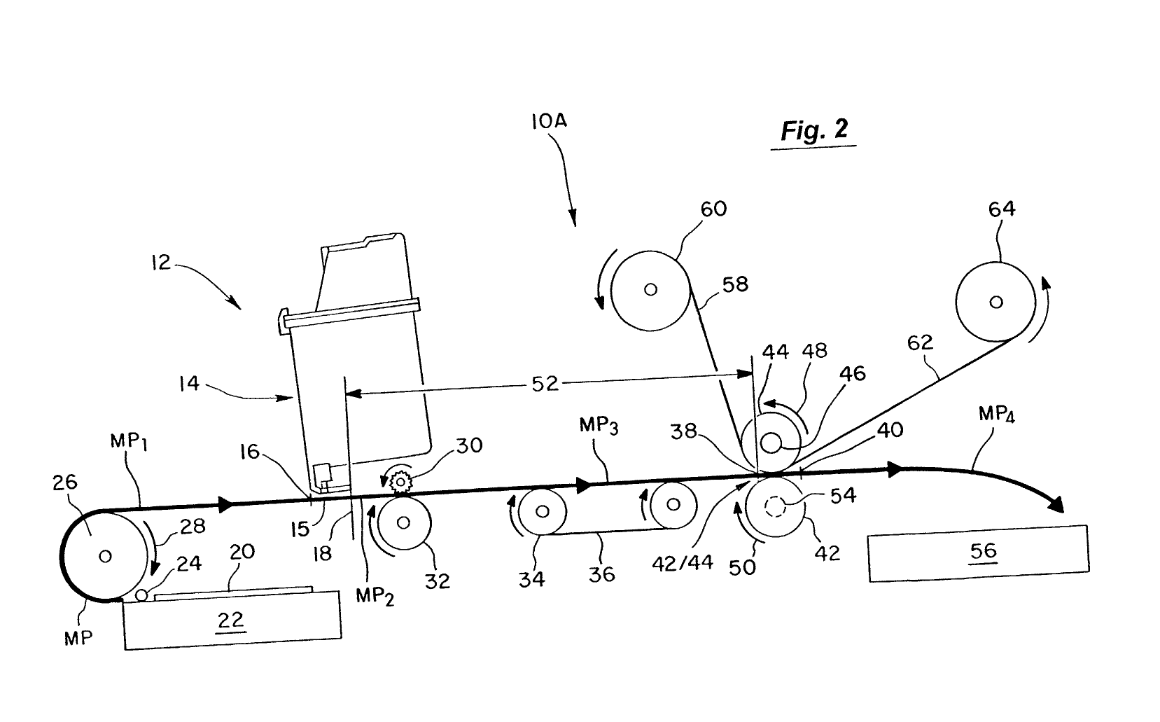

FIG. 2 shows another embodiment of this invention wherein the print side (top side) of a sheet passing through the inkjet printer 10A, in addition to being subjected to heat and pressure by the roller system 42/44, is provided with mechanical protection in the form of a cover sheet made of a clear plastic film material 58. Such a clear plastic film material 58 gives a printed image a desirable, glossy appearance. Processes for adding such clear plastic film materials to an image bearing sheet are often referred to as “thermal transfer overlaying” processes. Consequently, FIG. 2 depicts a highly generalized thermal transfer overlaying process wherein a clear plastic material 58 is fed from a supply reel 60 on to the top surface of a sheet of media 20. The sheet of media 20 and the clear plastic material 56 pass through the roller 42, roller 44 interface in registry with each other under pressure and heat conditions such that the printed material on the media 20 is simultaneously dried and permanently covered with a layer of the clear plastic material 58. Such thermal transfer overlay processes also usually include a reel system that takes up unused clear plastic material and any carrier sheet or runner with which the clear plastic material 58 is associated in its unused state. Thus, FIG. 2 shows this unused material 62 being taken up by a take-up reel 64. Those skilled in this art also will appreciate that a sheet of print media that receives printing on each side (duplex printed) can be covered by a clear plastic material (such as clear plastic material 58) on each side.

Although the preceding disclosure sets forth a number of embodiments of the present invention, those skilled in this art will well appreciate that other arrangements or embodiments, not precisely set forth in the specifications of this patent disclosure, could be practiced under the teachings of the present invention. Therefore, the scope of this invention should only be limited by the scope of the following claims.

I claim:

1. A printer having a printing device for printing on a sheet of print media in a print zone and wherein said printer further comprises a pressure/heater device that is positioned downstream from the print zone by a media path distance such that the sheet of print media leaves the print zone before it enters the pressure/heater device.

2. The printer of claim 1 wherein the media path distance between the print zone and the pressure/heater device is greater than the length of the sheet of print media.

3. The printer of claim 1 wherein the media path distance is at least 11 inches.

4. The printer of claim 1 wherein the media path between the print zone and the pressure/heater device is substantially linear.

5. The printer of claim 1 wherein the pressure/heater device is comprised of a pressure roller and a heater roller that cooperate in a manner that defines a pressure roller/heater roller interface through which a sheet of paper is drawn under conditions of pressure and heat.

6. The printer of claim 1 wherein the pressure/heater device is comprised of a powered pressure roller and a passive heater roller.

7. The printer of claim 1 wherein the pressure/heater device has a heater in both a pressure roller and a heater roller.

8. The printer of claim 1 wherein the printing device is a color printing device.

9. An inkjet printer having a printhead for printing on a sheet of print media in a print zone and wherein said inkjet printer further comprises a pressure/heater device that is positioned downstream from the print zone by a media path distance such that the sheet of print media leaves the print zone before it enters the pressure/heater device.

10. The inkjet printer of claim 9 wherein the media path distance between the print zone and the pressure/heater device is greater than the length of the sheet of media undergoing an inkjet printing process in the inkjet printer.

11. The inkjet printer of claim 9 wherein the media path distance is at least 11 inches.

12. The inkjet printer of claim 9 wherein the media path between the print zone and the pressure/heater device is substantially linear.

13. The inkjet printer of claim 9 wherein the pressure/heater device is comprised of a pressure roller and a heater roller that cooperate in a manner that defines a pressure roller/heater roller interface through which a sheet of paper is drawn under conditions of pressure and heat.

14. The inkjet printer of claim 9 wherein the pressure/heater device is comprised of a powered pressure roller and a passive heater roller.

15. The printer of claim 9 wherein the pressure/heater device has a heater in both a pressure roller and a heater roller.

16. The printer of claim 9 wherein said printer is a color printing device.

17. An inkjet printer having a printhead for printing on a sheet of print media in a print zone wherein said inkjet printer further comprises a pressure/heater device that is positioned downstream from the print zone by a media path distance such that the sheet of print media leaves the print zone before it enters the pressure/heater device and wherein said printer is further provided with a thermal transfer layer dispensing device.

18. The inkjet printer of claim 17 wherein the media path distance between the print zone and the pressure/heater device is greater than the length of the sheet of paper undergoing an inkjet printing process in the inkjet printer.

19. The inkjet printer of claim 17 wherein the media path distance is at least 11 inches.

20. The inkjet printer of claim 17 wherein the pressure/heater device is comprised of a pressure roller and a heater roller that cooperate in a manner that defines a pressure roller/heater roller interface through which a sheet of paper is drawn under conditions of pressure and heat.
